(19) United States
(12) Patent Application Publication
(10) Pub. No.: US 2025/0295965 A1
(43) Pub. Date: Sep. 25, 2025

(54) REAL TIME KINEMATICS IN GOLF FLEET VEHICLES

(71) Applicant: Textron Inc., Providence, RI (US)

(72) Inventors: Brian David Wanta, North Augusta, SC (US); Preston Sering Easly, Martinez, GA (US); Ionut Gabriel Bungeanu, Stefanesti (RO)

(73) Assignee: Textron Inc., Providence, RI (US)

(21) Appl. No.: 18/614,559

(22) Filed: Mar. 22, 2024

(51) Int. Cl. A63B 55/60; G01S 19/43

(52) U.S. Cl. CPC A63B 55/61; G01S 19/43

(57) ABSTRACT

A vehicle system includes a RTK hub, a vehicle, and one or more processing circuits. The RTK hub is configured to be positioned at a known location, and includes a first communications interface configured to facilitate acquiring a hub GPS position of the RTK hub based on a hub GPS signal acquired from a GNSS satellite. The vehicle includes a sensor configured to acquire a vehicle GPS position of the vehicle based on a vehicle GPS signal from the GNSS satellite and a second communications interface configured to facilitate communications between the vehicle and the RTK hub. The processing circuits are configured to determine corrective position data based on the hub GPS position and the known location, determine a corrective position of the vehicle based on the vehicle GPS position and the corrective position data, and control an operation of the vehicle based on the corrective position of the vehicle.

### BACKGROUND

Golf carts are commonly used by golfers while playing a round of golf to drive between holes, to their ball, and to carry their bags. Other vehicles, such as drink carts, ground maintenance vehicles, recreational vehicles, utility vehicles, etc. are also commonly found at a golf course. Keep-out geofences may be established around areas of the golf course where the golf carts and other vehicles should not drive. These areas may include greens, tee boxes, buildings, water, woods, among others. When the golf cart or the other vehicles drive in the area defined by the keep-out geofence, the operation thereof may be limited.

### SUMMARY

One embodiment relates to a vehicle system. The vehicle system includes a real-time kinematics (RTK) hub, a vehicle, and one or more processing circuits. The RTK hub is configured to be positioned at a known location at a golf course. The RTK hub includes a first communications interface configured to facilitate acquiring a hub GPS position of the RTK hub based on a hub GPS signal acquired from a global navigation satellite system (GNSS) satellite. The vehicle includes a chassis, a plurality of tractive assemblies coupled to the chassis, a prime mover configured to drive one or more of the plurality of tractive assemblies, a sensor configured to facilitate acquiring a vehicle GPS position of the vehicle based on a vehicle GPS signal acquired from the GNSS satellite, and a second communications interface configured to facilitate communications between the vehicle and the RTK hub. The one or more processing circuits are configured to determine corrective position data based on the hub GPS position and the known location, determine a corrective position of the vehicle based on the vehicle GPS position and the corrective position data, and control an operation of the vehicle based on the corrective position of the vehicle.

Another embodiment relates to a golf cart. The golf cart includes a chassis, a plurality of tractive assemblies, a prime mover configured to drive one or more of the plurality of tractive assemblies, a sensor configured to facilitate acquiring a GPS position of the golf cart based on a GPS signal, a communications interface configured to facilitate communications with a real-time kinematics (RTK) system configured to be positioned at a known location at a golf course, and a controller. The controller is configured to determine a corrective position of the golf cart based on (i) corrective position data received from the RTK system and (ii) the GPS position of the golf cart, and facilitate selectively limiting or permitting operation of the prime mover based on the corrective position of the golf cart.

Still another embodiment relates to a vehicle system. The vehicle system includes one or more processing circuits including one or more memory devices storing instructions thereon that, when executed by one or more processors, cause the one or more processors to: acquire first GPS data indicative of a position of a real-time kinematics (RTK) system where the RTK system associated with a known position, determine corrective position data based on the first GPS data and the known position, acquire second GPS data indicative of a GPS location of a vehicle, determine a corrective position of the vehicle based on the corrective position data and the second GPS data, and control operation of the vehicle based on the corrective position.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a vehicle, according to an exemplary embodiment.

FIG. 2 is a schematic block diagram of the vehicle of FIG. 1, according to an exemplary embodiment.

FIG. 3 is a is schematic block diagram of a site monitoring and control system including a plurality of the vehicles of FIG. 1, according to an exemplary embodiment.

FIG. 4 is a is schematic block diagram of a vehicle navigation system including a plurality of the vehicles of FIG. 1, according to an exemplary embodiment.

FIG. 5 is a top view of a golf course including the vehicle of FIG. 1, according to an exemplary embodiment.

FIG. 6 is a top view of a golf course including the vehicle of FIG. 1, according to an exemplary embodiment.

FIG. 7 is a block diagram of a method for controlling operation of the vehicle of FIG. 1, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

According to an exemplary embodiment, the vehicle of the present disclosure includes a vehicle system including a controller configured to control an operation (e.g., permit operation, limit operation, etc.) of the vehicle based on corrective position data. The vehicle may include a communications device (e.g., a sensor, a communications interface, etc.) to facilitate communications with an on-site system (e.g., a RTK base station or hub). The on-site system, which is associated with a known, fixed location at the site (e.g., at the golf course), may be configured to communicate with a GNSS satellite. Based on (i) the communications between the on-site system and the GNSS satellite and (ii) the known, fixed location of the on-site system, corrective position data can be determined. The vehicle may include a GPS sensor configured to acquire GPS data indicative of a GPS position (e.g., a tracked position) of the vehicle. The GPS position determined based on GPS data may be different than a true position of the vehicle. This difference may be caused by GPS drift (e.g., signal interference (e.g., geomagnetic radiation), solar storms, signal obstruction (e.g., tree cover, building cover, etc.), weather (e.g., rain, snow, pressure, etc.), malfunctioning sensors, and/or any other combination of technical or external factors). To correct undesirable controlling of the operation of the vehicle as a result of the GPS drift, a corrective position of the vehicle is determined based on the GPS position of the vehicle and the corrective position data. The corrective position of the vehicle may be transmitted to an off-site server configured to control operation of the vehicle based on the corrective position.

### Overall Vehicle

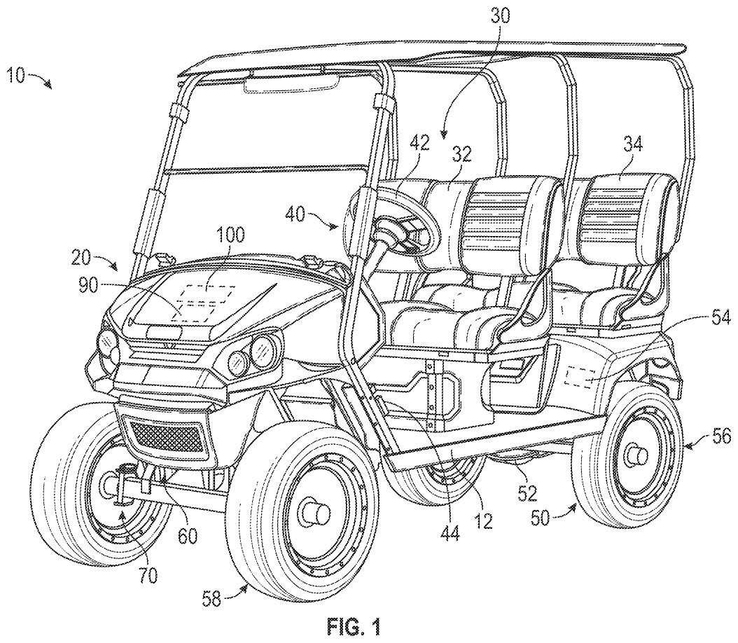

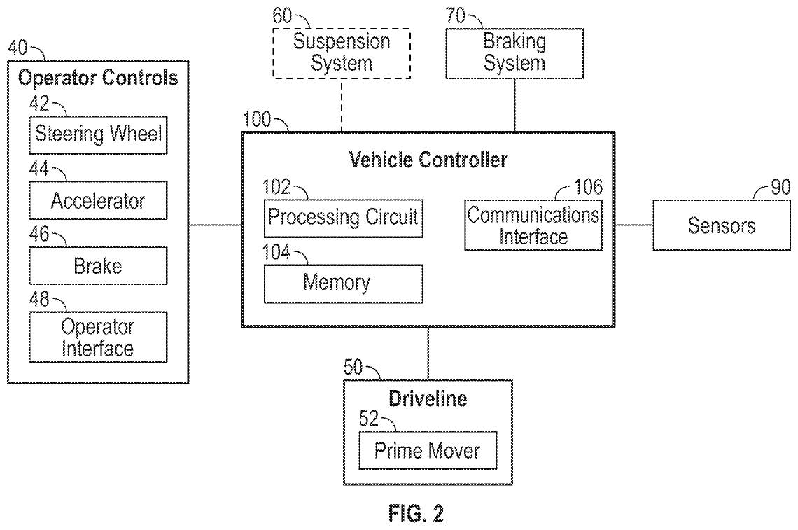

As shown in FIGS. 1 and 2, a machine or vehicle, shown as vehicle 10, includes a chassis, shown as frame 12; a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; one or more first sensors, shown as sensors 90; and a vehicle control system, shown as vehicle controller 100, coupled to the operator controls 40, the driveline 50, the suspension system 60, the braking system 70, and the sensors 90. In some embodiments, the vehicle 10 includes more or fewer components.

According to an exemplary embodiment, the vehicle 10 is an off-road machine or vehicle. In some embodiments, the off-road machine or vehicle is a lightweight or recreational machine or vehicle such as a golf cart, an all-terrain vehicle (“ATV”), a utility task vehicle (“UTV”), and/or another type of lightweight or recreational machine or vehicle. In some embodiments, the off-road machine or vehicle is a chore product such as a lawnmower, a turf mower, a push mower, a ride-on mower, a stand-on mower, aerator, turf sprayers, bunker rake, and/or another type of chore product (e.g., that may be used on a golf course).

According to the exemplary embodiment shown in FIG. 1, the occupant seating area 30 includes a plurality of rows of seating including a first row of seating, shown as front row seating 32, and a second row of seating, shown as rear row seating 34. In some embodiments, the occupant seating area 30 includes a third row of seating or intermediate/middle row seating positioned between the front row seating 32 and the rear row seating 34. According to the exemplary embodiment shown in FIG. 1, the rear row seating 34 is facing forward. In some embodiments, the rear row seating 34 is facing rearward. In some embodiments, the occupant seating area 30 does not include the rear row seating 34. In some embodiments, in addition to or in place of the rear row seating 34, the vehicle 10 includes one or more rear accessories. Such rear accessories may include a golf bag rack, a bed, a cargo body (e.g., for a drink cart), and/or other rear accessories.

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower an implement, etc.). As shown in FIGS. 1 and 2, the operator controls 40 include a steering interface (e.g., a steering wheel, joystick(s), etc.), shown steering wheel 42, an accelerator interface (e.g., a pedal, a throttle, etc.), shown as accelerator 44, a braking interface (e.g., a pedal), shown as brake 46, and one or more additional interfaces, shown as operator interface 48. The operator interface 48 may include one or more displays and one or more input devices. The one or more displays may be or include a touchscreen, a LCD display, a LED display, a speedometer, gauges, warning lights, etc. The one or more input device may be or include buttons, switches, knobs, levers, dials, etc.

According to an exemplary embodiment, the driveline 50 is configured to propel the vehicle 10. As shown in FIGS. 1 and 2, the driveline 50 includes a primary driver, shown as prime mover 52, an energy storage device, shown as energy storage 54, a first tractive assembly (e.g., axles, wheels, tracks, differentials, etc.), shown as rear tractive assembly 56, and a second tractive assembly (e.g., axles, wheels, tracks, differentials, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor and the energy storage 54 is a battery system. In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiment shown in FIG. 1, the rear tractive assembly 56 includes rear tractive elements and the front tractive assembly 58 includes front tractive elements that are configured as wheels. In some embodiments, the rear tractive elements and/or the front tractive elements are configured as tracks. The rear tractive assembly 56 and the front tractive assembly 58 may be configured to engage a ground surface to support the vehicle 10.

According to an exemplary embodiment, the prime mover 52 is configured to provide power to drive the rear tractive assembly 56 and/or the front tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 58. The rear tractive assembly 56 and/or the front tractive assembly 58 may include a drive shaft, a differential, and/or an axle. In some embodiments, the rear tractive assembly 56 and/or the front tractive assembly 58 include two axles or a tandem axle arrangement. In some embodiments, the rear tractive assembly 56 and/or the front tractive assembly 58 are steerable (e.g., using the steering wheel 42). In some embodiments, both the rear tractive assembly 56 and the front tractive assembly 58 are fixed and not steerable (e.g., employ skid steer operations).

In some embodiments, the driveline 50 includes a plurality of prime movers 52. By way of example, the driveline 50 may include a first prime mover 52 that drives the rear tractive assembly 56 and a second prime mover 52 that drives the front tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 58, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 56, a second prime mover 52 that drives a first one of the front tractive elements, and a third prime mover 52 that drives a second one of the front tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 58 (e.g., the front axle, the front tractive elements, etc.) and (ii) one or more rear braking components positioned to facilitate braking one or more components of the rear tractive assembly 56 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements.

The sensors 90 may include various sensors positioned about the vehicle 10 to acquire vehicle information or vehicle data regarding operation of the vehicle 10 and/or the location thereof. By way of example, the sensors 90 may include an accelerometer, a gyroscope, a compass, a position sensor (e.g., a GPS sensor, etc.), an inertial measurement unit (“IMU”), suspension sensor(s), wheel sensors, an audio sensor or microphone, a camera, an optical sensor, a proximity detection sensor, and/or other sensors to facilitate acquiring vehicle information or vehicle data regarding operation of the vehicle 10 and/or the location thereof. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data.

The vehicle controller 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle controller 100 includes a processing circuit 102, a memory 104, and a communications interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein. According to an exemplary embodiment, the memory 104 includes computer code modules (e.g., executable code, object code, source code, script code, machine code, etc.) configured for execution by the processing circuit 102. In some embodiments, the vehicle controller 100 may represent a collection of processing devices. In such cases, the processing circuit 102 represents the collective processors of the devices, and the memory 104 represents the collective storage devices of the devices.

In one embodiment, the vehicle controller 100 is configured to selectively engage, selectively disengage, control, or otherwise communicate with components of the vehicle 10 (e.g., via the communications interface 106, a controller area network (“CAN”) bus, etc.). According to an exemplary embodiment, the vehicle controller 100 is coupled to (e.g., communicably coupled to) components of the operator controls 40 (e.g., the steering wheel 42, the accelerator 44, the brake 46, the operator interface 48, etc.), components of the driveline 50 (e.g., the prime mover 52), components of the braking system 70, and the sensors 90. By way of example, the vehicle controller 100 may send and receive signals (e.g., control signals, location signals, etc.) with the components of the operator controls 40, the components of the driveline 50, the components of the braking system 70, the sensors 90, and/or remote systems or devices (via the communications interface 106 as described in greater detail herein).

### Site Monitoring and Control System

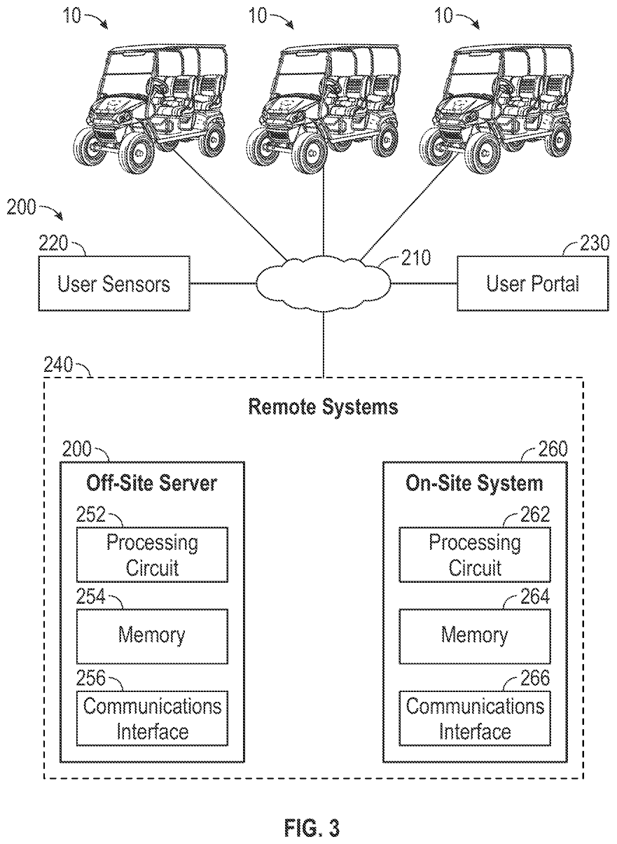

As shown in FIG. 3, a monitoring and control system, shown as site monitoring and control system 200, includes one or more vehicles 10; one or more second sensors, shown as user sensors 220, positioned remote or separate from the vehicles 10; an operator interface, shown as user portal 230, positioned remote or separate from the vehicles 10; and one or more external processing systems, shown as remote systems 240, positioned remote or separate from the vehicles 10. The vehicles 10, the user sensors 220, the user portal 230, and the remote systems 240 communicate via one or more communications protocols (e.g., Bluetooth, Wi-Fi, cellular, radio, through the Internet, etc.) through a network, shown as communications network 210.

The user sensors 220 may be or include one or more sensors that are carried by or worn by an operator of one of the vehicles 10. By way of example, the user sensors 220 may be or include a wearable sensor (e.g., a smartwatch, a fitness tracker, a pedometer, hear rate monitor, etc.) and/or a sensor that is otherwise carried by the operator (e.g., a smartphone, etc.) that facilitates acquiring and monitoring operator data (e.g., physiological conditions such a temperature, heartrate, breathing patterns, etc.; location; movement; etc.) regarding the operator. The user sensors 220 may communicate directly with the vehicles 10, directly with the remote systems 240, and/or indirectly with the remote systems 240 (e.g., through the vehicles 10 as an intermediary).

The user portal 230 may be configured to facilitate operator access to dashboards including the vehicle data, the operator data, information available at the remote systems 240, etc. to manage and operate the site (e.g., golf course) such as for advanced scheduling purposes, to identify persons braking course guidelines or rules, to monitor locations of the vehicles 10, etc. The user portal 230 may also be configured to facilitate operator implementation of configurations and/or parameters for the vehicles 10 and/or the site (e.g., setting speed limits, setting geofences, etc.). The user portal 230 may be or may be accessed via a computer, laptop, smartphone, tablet, or the like.

As shown in FIG. 3, the remote systems 240 include a first remote system, shown as off-site server 250, and a second remote system, shown as on-site system 260 (e.g., in a clubhouse of a golf course, on the golf course, etc.). In some embodiments, the remote systems 240 include only one of the off-site server 250 or the on-site system 260. As shown in FIG. 3, (a) the off-site server 250 includes a processing circuit 252, a memory 254, and a communications interface 256 and (b) the on-site system 260 includes a processing circuit 262, a memory 264, and a communications interface 266.

According to an exemplary embodiment, the remote systems 240 (e.g., the off-site server 250 and/or the on-site system 260) are configured to communicate with the vehicles 10 and/or the user sensors 220 via the communications network 210. By way of example, the remote systems 240 may receive the vehicle data from the vehicles 10 and/or the operator data from the user sensors 220. The remote systems 240 may be configured to perform back-end processing of the vehicle data and/or the operator data. The remote systems 240 may be configured to monitor various global positioning system (“GPS”) information and/or real-time kinematics (“RTK”) information (e.g., position/location, speed, direction of travel, geofence related information, etc.) regarding the vehicles 10 and/or the user sensors 220. The remote systems 240 may be configured to transmit information, data, commands, and/or instructions to the vehicles 10. By way of example, the remote systems 240 may be configured to transmit GPS data and/or RTK data based on the GPS information and/or RTK information to the vehicles 10 (e.g., which the vehicle controllers 100 may use to make control decisions). By way of another example, the remote systems 240 may send commands or instructions to the vehicles 10 to implement.

According to an exemplary embodiment, the remote systems 240 (e.g., the off-site server 250 and/or the on-site system 260) are configured to communicate with the user portal 230 via the communications network 210. By way of example, the user portal 230 may facilitate (a) accessing the remote systems 240 to access data regarding the vehicles 10 and/or the operators thereof and/or (b) configuring or setting operating parameters for the vehicles 10 (e.g., geofences, speed limits, times of use, permitted operators, etc.). Such operating parameters may be propagated to the vehicles 10 by the remote systems 240 (e.g., as updates to settings) and/or used for real time control of the vehicles 10 by the remote systems 240.

### Real-Time Kinematics System

According to an exemplary embodiment, the site monitoring and control system 200, including the vehicle controller 100, the user sensors 220, the user portal 230, and the remote systems 240, is configured to facilitate improving or enhancing location detection of the vehicles 10 and associated control thereof based on location. Further, it should be understood that any of the functions or processes described herein with respect to the site monitoring and control system 200 may be performed by the vehicle controller 100 and/or the remote systems 240. By way of example, data collection may be performed by the vehicle controller 100 and data analytics may be performed by the vehicle controller 100. By way of another example, data collection may be performed by the vehicle controller 100 and data analytics may be performed by the remote systems 240. By way of yet another example, data collection may be performed by the vehicle controller 100, a first portion of data analytics may be performed by the vehicle controller 100, and a second portion of data analytics may be performed by the remote systems 240. By way of still another example, a first portion of data collection may be performed by the vehicle controller 100, a second portion of data collection may be performed by the remote systems 240, and data analytics may be performed by the vehicle controller 100 and/or the remote systems 240.

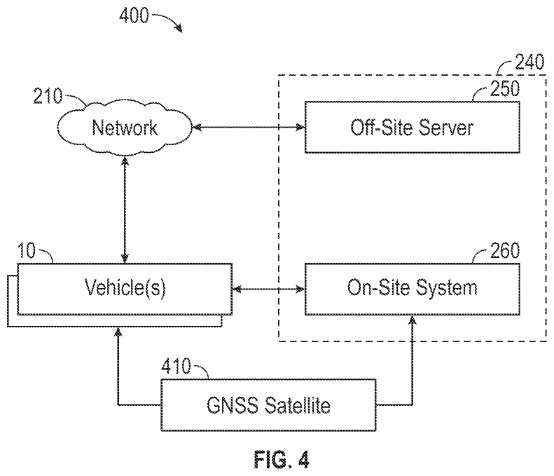

As shown in FIG. 4, a system (e.g., real-time kinematics system, location correction system, control system, tracking system, location correction system, a navigation system, etc.), shown as system 400, includes one or more of the vehicles 10, the network 210, the remote systems 240 including the off-site server 250 and the on-site system 260, and a global navigation satellite system (“GNSS”), shown as GNSS satellite 410. The vehicles 10, the remote systems 240, and the GNSS satellite 410 communicate via one or more communications protocols (e.g., Bluetooth, Wi-Fi, cellular, radio, through the Internet, satellite communications protocols, etc.) directly and/or through the communications network 210. Generally, the system 400 is configured to determine and correct geographic positions of the vehicles 10 using RTK information. Traditional GPS positioning using GNSS typically has an accuracy within a few meters. In some instances (e.g., during solar storms), this accuracy can decrease to be within more than ten meters. Such inaccurate position determination may cause undesirable performance of the vehicles 10 when position-based control features are implemented thereon. The RTK information may be used to correct these inaccuracies by correcting the GPS position to be within centimeters of the true position of the vehicles 10.

According to an exemplary embodiment, the on-site system 260 is configured as a RTK system configured to provide RTK information to the vehicles 10. The on-site system 260 may be a stationary, physical, base station or hub located on site (e.g., in a clubhouse of a golf course, on the golf course, etc.). The on-site system 260 may be calibrated (e.g., during installation at the golf course) to establish a fixed, precise, and stationary location at which the on-site system 260 is positioned. This fixed, precise, and stationary location is a reference location (e.g., a known location/position, a true location/position, etc.) that may be stored by the memory 264 of the on-site system 260. In some embodiments, the on-site system 260 transmits data associated with the reference location thereof to the vehicles 10 and/or the off-site server 250. The reference location may be used during a correction process to correct the position of the vehicles 10 relative to other features of the golf course (e.g., geofences established around hazards, greens, pin locations, buildings, etc.).

According to an exemplary embodiment, the on-site system 260 (e.g., via the communications interface 266) is configured to receive and transmit signals associated with RTK information of the on-site system 260 (e.g., a GPS position of the on-site system 260) with the vehicles 10 and the GNSS satellite 410. The on-site system 260 may be configured to communicate with the GNSS satellite 410 to receive a signal (e.g., a GPS signal, a communication signal, etc.) associated with a GPS position of the on-site system 260. The signal from the GNSS satellite 410 may include additional information related to the GNSS satellite 410 such as the relative position of the GNSS satellite 410 within space (e.g., ephemeris data), a time that the signal was transmitted, a unique identifier associated with the GNSS satellite 410, or still yet other information. In some embodiments, the GNSS satellite 410 continuously or substantially continuously (e.g., once every second or at a quicker frequency) transmits signals associated with the GPS position of the on-site system 260 to the on-site system 260. In some embodiments, the GNSS satellite 410 periodically transmits signals associated with the GPS position of the on-site system 260 to the on-site system 260 (e.g., every ten seconds, every thirty seconds, every minute, etc.). In some embodiments, the on-site system 260 is configured to receive and transmit signals with two or more GNSS satellites 410. In such embodiments, the on-site system 260 determines a GPS position thereof by triangulating the signals from the two or more GNSS satellites 410.

The RTK information (e.g., the GPS position of the on-site system 260 based on the communication with the GNSS satellite 410, the reference location of the on-site system 260, etc.) may be used to correct position data of the vehicles 10. The on-site system 260 may be configured to compare (i) the GPS position received from the GNSS satellite 410 based on the communication between the GNSS satellite 410 and the on-site system 260 with (ii) the reference location of the on-site system 260. Based on the comparison between the GPS position and the reference location, the on-site system 260 is configured to determine corrective position data (e.g., error data). The corrective position data may be indicative of an error or difference between the GPS position and the reference location of the on-site system 260 (e.g., errors/differences caused by GPS drift as discussed in greater detail below).

In some embodiments, the on-site system 260 is configured to transmit a signal associated with the GPS position and the reference location of the on-site system 260 to the vehicle 10. In such embodiments, the communications interface 106 of the vehicle controller 100 is configured to receive the signal, and the vehicle controller 100 is configured to process the signal and determine the corrective position data indicative of an error or difference between the GPS position and the reference location of the on-site system 260. In other embodiments, the on-site system 260 is configured to transmit a signal associated with the GPS position and the reference location of the on-site system 260 to the off-site server 250. In such embodiments, the communications interface 266 of the off-site server 250 is configured to receive the signal, and the off-site server 250 is configured to process the signal and determine the corrective position data indicative of an error or difference between the GPS position and the reference location of the on-site system 260.

The error or difference between the GPS position and the reference location of the on-site system 260 (e.g., an error or difference between a GPS location of the vehicle 10 and a true location of the vehicle 10) may be caused by signal interference (e.g., geomagnetic radiation), solar storms, signal obstruction (e.g., tree cover, building cover, etc.), weather (e.g., rain, snow, pressure, etc.), control system quality, malfunctioning sensors, and/or any other combination of internal hardware or external factors. The difference between the GPS position and a real-time, actual position (e.g., a true position of the vehicle 10, the reference location of the on-site system 260, etc.) may be referred to herein as location or GPS drift. Because of the difference between the GPS position and the real-time position, the site monitoring and control system 200 may determine, based on the GPS position, that the vehicle 10 is operating in a restricted area (e.g., near/on a green or tee box, near/on a hazard such as ground under repair, an area defined by a geofence, a non-drivable area, etc.) when in reality, the real-time position (e.g., the true position of the vehicle 10, the reference location of the on-site system 260, etc.) of the vehicle 10 is not in the restricted area. In such an example, the site monitoring and control system 200 may undesirably limit the operation of the vehicle 10. Similarly, because of the difference between the GPS position and the real-time position, the site monitoring and control system 200 may determine, based on the GPS position, that the vehicle 10 is not operating in the restricted area (e.g., operating in the drivable area) when in reality, the real-time position of the vehicle 10 is in the restricted area. In such an example, the site monitoring and control system 200 may undesirably permit operation of the vehicle 10 within the restricted area.

To correct (e.g., adjust for, account for, etc.) the undesirable controlling of the operation of the vehicles 10 as a result of the GPS drift, the system 400 is configured to determine a corrective position of the vehicles 10 based on the GPS data of the vehicles 10 (e.g., vehicle GPS data) and the corrective position data (e.g., associated with a difference between a GPS position and a real-time position) and make operational decisions based on the corrective position. In some embodiments, the GPS data of the vehicles 10 is associated with the GPS position of the vehicles 10 and is determined (e.g., acquired, monitored, collected, etc.) by the sensors 90 and/or the user sensors 220 from the GNSS satellite 410. Controlling operation of the vehicles 10 based on the corrective position ensures that the difference between the real-time positions and the GPS positions caused by GPS drift does not adversely affect operation of the vehicles 10 (e.g., limiting driving operations of the vehicles 10 when the vehicles 10 are in the drivable areas, permitting driving operations of the vehicles 10 when the vehicles 10 are in the restricted areas, etc.).

According to an exemplary embodiment, the vehicle controller 100 of the vehicle 10 is configured to determine the corrective position of the vehicle 10 based on the GPS data of the vehicle 10 and the corrective position data (e.g., determined by the on-site system 260, the off-site server 250, and/or the vehicle controller 100), and transmit the corrective position to the off-site server 250 such that operation of the vehicle 10 is controlled by the off-site server 250 based on the corrective position (and not based on the potentially wrong GPS position for the vehicle 10 as a result of GPS drift). In other embodiments (e.g., where the vehicle controller 100 does not determine the corrective position), the vehicle controller 100 is configured to transmit the GPS data regarding the GPS position of the vehicle 10 and/or the corrective position data (e.g., if the on-site system 260 does not transmit the corrective position data to the off-site server 250) to the off-site server 250 such that the off-site server 250 can determine the corrective position of the vehicle 10 and control operation of the vehicle 10 based on the corrective position (and not based on the potentially wrong GPS data for the vehicle 10 as a result of GPS drift). By way of example, the corrective position accounts for the errors between the real-time positions and the GPS positions caused by GPS drift because the corrective position is determined based on the corrective position data. Therefore, the corrective position determined by the vehicle controller 100 and/or the off-site server 250 is indicative of the real-time position of the vehicle 10.

According to an exemplary embodiment, the on-site system 260 and the vehicles 10 are continuously or substantially continuously in communication such that the system 400 can continuously or substantially continuously determine the corrective position of each vehicle 10, thereby continuously or substantially continuously providing corrective position data indicative of the corrective position and/or the corrective position of the vehicles 10 to the off-site server 250.

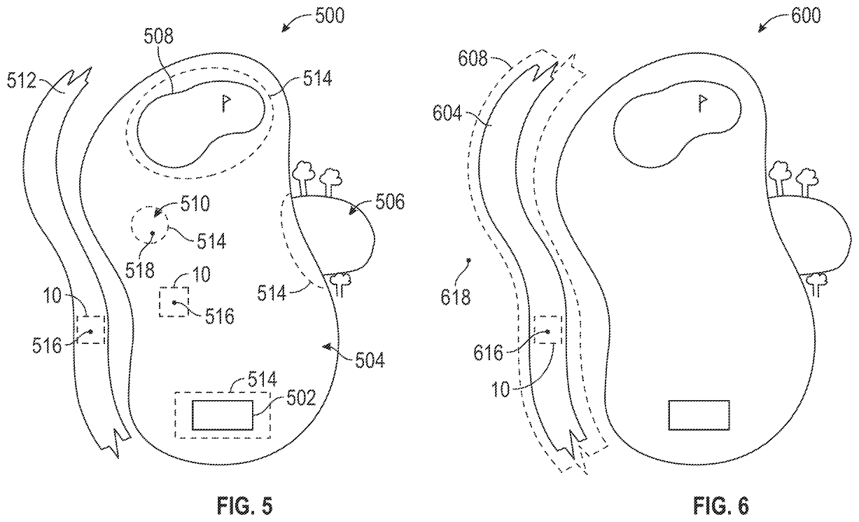

As shown in FIG. 5, the vehicle 10 may be a golf cart driven by an operator playing golf on a golf course 500. In some embodiments, the vehicle 10 is a drink cart, a cart driven by an employee of the golf course 500 monitoring the pace of play of golfers, a cart driven by the maintenance crew working at the golf course 500, or another type of vehicle or vehicle commonly found at golf courses (e.g., a turf mower, a sprayer, an aerator, a bunker rake, etc.). A hole of the golf course 500 is shown including a tee box 502; a fairway 504; a water hazard, woods, fescue, etc., shown as out-of-bounds area 506; a putting green, shown as green 508; an area in the fairway 504 that is under repair, a non-playable area, etc., shown as hazard 510; and a path, a trail, a cart route, etc., shown as cart path 512.

The golf course 500 includes areas that should not be driven on, in, or around by the vehicle 10. By way of example, these areas may include the tee box 502, the out-of-bounds area 506, the fairway 504 during certain conditions (e.g., rain, flooding, under repair, etc.), the green 508, the hazard 510, private property along the golf course 500, a club house of the golf course 500, and/or another area of the golf course 500. Driving on, in, or around these areas by the vehicle 10 may damage the golf course 500, be dangerous for an operator of the vehicle 10, damage the vehicle 10, be illegal (e.g., trespassing on private property), etc. Collectively, these areas are hereinafter referred to as restricted areas. Accordingly, one or more geofences (e.g., a virtual boundary, a virtual fence, etc.), shown as geofences 514, may be established around the restricted areas. The geofences 514 may be areas or boundaries defined around the restricted areas to control and manage the operation of the vehicle 10 on the golf course 500. By way of example, when the vehicle 10 is driven beyond the virtual boundary of the geofence 514 (i.e., driven into a restricted area), the operation of the prime mover 52 of the vehicle 10 may be limited (e.g., limit speeds below 5 miles per hour, prevent forward travel of the vehicle 10, limit the vehicle 10 to backward travel only, disabled, limited or restricted operation, etc.). Areas of the golf course 500, such as the cart path 512, a parking lot of the golf course 500, the fairway 504, a cart return area, etc. that are not restricted areas defined by a geofence 514 may be drivable (e.g., navigable, permitted, unrestricted operation, etc.) by the vehicle 10, and are hereinafter referred to as the drivable areas. In some embodiments, a cart path only rule may be implemented where the vehicle 10 is supposed to drive on the cart path 512 only (e.g., after or during heavy rainfall). In such an embodiment, the geofence 514 may be established everywhere except for the cart path 512.

As shown in FIG. 5, a location (e.g., real-time position, corrective position, true location, etc.), shown as true location 516, of the vehicle 10 may be different than a tracked position of the vehicle 10 determined based on GPS data (e.g., collected by the sensors 90 and/or the user sensors 220), shown as tracked location 518. The true location 516 may be different from the tracked location 518 as a result of GPS drift discussed in greater detail above.

According to an exemplary embodiment, the system 400 (e.g., the vehicle controller 100, the off-site server 250, the on-site system 260, etc.) may be configured to change or correct the tracked location 518 (e.g., compensate for GPS drift). By way of example, the system 400 may be configured to force the tracked location 518 to be within the drivable area in response to a determination, based on the true location 516, that the vehicle 10 is traveling in the drivable area and the tracked location 518 indicates that the vehicle 10 is in the restricted area. By way of another example, the system 400 may be configured to force the tracked location 518 to be within the restricted area in response to a determination, based on the true location 516, that the vehicle 10 is traveling in the restricted area and the tracked location 518 indicates that the vehicle 10 is in the drivable area. In some embodiments, when a determination is made that the true location 516 is different than the tracked location 518 (e.g., the coordinates are different), the system 400 may be configured to recalibrate (e.g., reset) the sensors 90 collecting the GPS data and/or send a signal commanding the user sensors 220 to recalibrate.

The system 400 (e.g., the vehicle controller 100, the off-site server 250, the on-site system 260, etc.) may control an operation of the operator controls 40, the driveline 50, the suspension system 60, the braking system 70, and/or any other component of the vehicle 10 based on the corrective position of the vehicle 10 relative to the geofences 514. By way of example, the system 400 may determine, based on the corrective position, that the vehicle 10 is operating (e.g., driving forward, driving backward, idling, stopped, parked, etc.) (i) in a drivable area, (ii) near a geofence 514 (e.g., within 5 yards of the geofence 514, within 10 yards of the geofence 514, etc.), or (iii) in a restricted area defined by the geofence 514. In response to a determination that the vehicle 10 is operating in a drivable area, the system 400 may facilitate (e.g., permit operation of the vehicle 10 in a first mode of operation) normal or unrestricted operation of the operator controls 40, the driveline 50, the suspension system 60, the braking system 70, and/or any other component of the vehicle 10. In response to a determination that the vehicle 10 is operating near or in the geofence 514, the system 400 may limit operation (e.g., limit operation of the vehicle 10 in a second mode of operation) of the operator controls 40, the driveline 50, the suspension system 60, the braking system 70, and/or any other component of the vehicle 10. By way of example, the system 400 may limit operation of the prime mover 52 such that the vehicle 10 (i) cannot exceed a threshold speed (e.g., 5 miles per hour, 2 miles per hour, etc.), (ii) is limited to rearward travel, and/or (iii) any other control to limit operation of the vehicle 10. In some embodiments, in response to a determination by the system 400 that the vehicle 10 is operating near the geofence 514, the operator interface 48 may display a warning providing an indication to the operator of the vehicle 10 of the geofence 514 (e.g., warning the operator of the location of the geofence 514, warning the operator that the vehicle 10 is approaching the geofence 514, etc.). In some embodiments, in response to a determination by the system 400 that the vehicle 10 is operating in the geofence 514, the operator interface 48 may display a warning providing instructions to the operator to navigate the vehicle 10 out of the geofence 514. In some embodiments, in response to a determination by the system 400 that the vehicle 10 is operating in the geofence 514, the operator interface 48 and/or the user portal 230 may display a warning, a distance indicating how far the vehicle 10 has traveled in the geofence 514, and/or a time indicating how long the vehicle 10 has been operating in the geofence 514. The parameters for triggering such warning may be set using the user portal 230. In some embodiments, in response to a determination by the system 400 that the vehicle 10 is operating in the geofence 514, the system 400 may disable/limit the vehicle 10, provide the warning on the operator interface 48, and/or provide the warning on the user portal 230.

According to an exemplary embodiment, the system 400 may permit operation of the vehicle 10 when the tracked location 518 indicates that that vehicle 10 is located in the restricted area, but the true location 516 indicates that the vehicle 10 is traveling in the drivable area. By way of example, the vehicle 10 may operate normally when the vehicle 10 is actually driving on the cart path 512, even though the tracked location 518 indicates that the vehicle 10 is located in a restricted area, such as the tee box 502, the fairway 504, the out-of-bounds area 506, the green 508, or the hazard 510. When the tracked location 518 indicates that that vehicle 10 is located in the drivable area, and the true location 516 indicates that the vehicle 10 is traveling in the drivable area, the system 400 may permit operation of the vehicle 10. When the tracked location 518 indicates that that vehicle 10 is located in the drivable area, but the true location 516 indicates that the vehicle 10 is traveling in the restricted area, the system 400 may limit operation of the vehicle 10. By way of example, the vehicle 10 may have limited operational capabilities when the vehicle 10 is located in a restricted area, such as the tee box 502, the fairway 504, the out-of-bounds area 506, the green 508, or the hazard 510, even though the tracked location 518 indicates that the vehicle 10 is in the drivable area (e.g., the cart path 512). When the tracked location 518 indicates that that vehicle 10 is located in the restricted area, and the true location 516 indicates that the vehicle 10 is traveling in the restricted area, the system 400 may limit operation of the vehicle 10.

As shown in FIG. 6, the vehicle 10 may be a golf cart driven by an operator playing golf on a golf course 600. A hole of the golf course 600 is shown including a path, a trail, a cart route, a parking lot, a paved surface, etc., shown as cart path 604.

The golf course 600 includes areas that should not be driven on, in, or around by the vehicle 10. By way of example, these areas may include a tee box, an out-of-bounds area, a fairway during certain conditions (e.g., rain, flooding, under repair, etc.), a green, hazards (e.g., water, woods, fescue, ground under repair, etc.), private property along the golf course 600, a club house of the golf course 600, and/or another area of the golf course 600. Driving on, in, or around these areas by the vehicle 10 may damage the golf course 600, be dangerous for an operator of the vehicle 10, damage the vehicle 10, be illegal (e.g., trespassing on private property), etc. Collectively, these areas are hereinafter referred to as restricted areas.

In some embodiments, a cart path only rule may be implemented where the vehicle 10 is supposed to drive on the cart path 604 only (e.g., after or during heavy rainfall, to avoid ground under repair, when the cart path 604 is a bridge crossing a river/pond, etc.). In such instances, as shown in FIG. 6, rather than defining geofences around the restricted areas (i.e., everywhere but the cart path 604), a geofence, shown as cart path geofence 608, is formed around the cart path 604. By way of example, when the vehicle 10 is driven beyond the virtual boundary of the cart path geofence 608 (i.e., driven off of the cart path 604 and into a restricted area), the operation of the prime mover 52 of the vehicle 10 may be limited (e.g., limit speeds below 5 miles per hour, prevent forward travel of the vehicle 10, limit the vehicle 10 to backward travel only, disabled, limited or restricted operation, etc.).

As shown in FIG. 6, a location (e.g., real-time position, corrective position, true location, etc.), shown as true location 616, of the vehicle 10 may be different than a tracked position of the vehicle 10 determined based on GPS data (e.g., collected by the sensors 90 and/or the user sensors 220, from the GNSS satellite 410, etc.), shown as tracked location 618. The true location 616 may be different from the tracked location 618 as a result of GPS drift discussed in greater detail above. Using previous GPS tracking technology, implementing the cart path geofence 608 was not possible due to the GPS drift issues and the typical width of the cart path 604 (i.e., the tracked location 618 would often be outside of the cart path and, therefore, lead to incorrectly limiting operation of the vehicles 10). However, by using RTK information and the corrective position processes disclosed here, the cart path geofence 608 becomes possible because of the significantly higher accuracy of the true location 616.

Based on the corrective position of the vehicle 10 determined from the corrective position data, the system 400 (e.g., the vehicle controller 100, the off-site server 250, the on-site system 260, etc.) may more accurately and effectively enforce the cart path only rule by controlling an operation of the vehicle 10 based on the corrective position of the vehicle 10 relative to the cart path geofence 608. By way of example, the system 400 may determine, based on the corrective position, that the vehicle 10 is operating (e.g., driving forward, driving backward, idling, stopped, parked, etc.) (i) on the cart path 604 (e.g., not in the restricted area defined by the geofence 608), (ii) near the boundary of the cart path geofence 608 (e.g., within inches of the boundary of the cart path geofence 608, etc.), and (iii) in the restricted area outside of by the cart path geofence 608 (e.g., everywhere except for the cart path 604).

In some embodiments, in response to a determination that the vehicle 10 is operating on the cart path 604 and inside the cart path geofence 608 (e.g., when the tracked location 518 indicates that that vehicle 10 is located in the restricted area, but the true location 516 indicates that the vehicle 10 is traveling on the cart path 604; when the tracked location 518 indicates that that vehicle 10 is located on the cart path 604, and the true location 516 indicates that the vehicle 10 is traveling on the cart path 604), the system 400 facilitates (e.g., permit operation of the vehicle 10 in a first mode of operation) normal or unrestricted operation of the operator controls 40, driveline 50, the suspension system 60, the braking system 70, and/or any other component of the vehicle 10.

In some embodiments, in response to a determination that the vehicle 10 is operating outside the cart path geofence 608 (e.g., when the tracked location 518 indicates that that vehicle 10 is located on the cart path 604, but the true location 516 indicates that the vehicle 10 is traveling in the restricted area; when the tracked location 518 indicates that that vehicle 10 is located in the restricted area, and the true location 516 indicates that the vehicle 10 is traveling in the restricted area), the system 400 limits operation (e.g., limit operation of the vehicle 10 in a second mode of operation) of the operator controls 40, driveline 50, the suspension system 60, the braking system 70, and/or any other component of the vehicle 10. By way of example, the system 400 may limit operation of the prime mover 52 such that the vehicle 10 (i) cannot exceed a threshold speed (e.g., 5 miles per hour, 2 miles per hour, etc.), (ii) is limited to rearward travel, and/or (iii) any other control to limit operation of the vehicle 10. In some embodiments, in response to a determination by the system 400 that the vehicle 10 is operating near or on the edge of the geofence 608 (e.g., a wheel just off the cart path 604), the operator interface 48 may display a warning providing an indication to the operator of the vehicle 10 regarding the cart path geofence 608 (e.g., warning the operator of the location of the cart path geofence 608, warning the operator that the vehicle 10 is approaching the edge of cart path geofence 608, an instruction to steer back onto the cart path 604, an instruction to stay on the cart path 604, etc.). In some embodiments, the system 400 is configured to prevent the vehicle 10 from leaving the cat path 604 (e.g., cause corrective steering to be implemented, preventing a steering wheel from turning a certain amount, etc.).

In some embodiments, the system 400 is configured to acquire positions of pin placements on the green 508 and the tee locations of the tee box 502 based on GPS data (e.g., tee GPS data, pin GPS data, etc.) acquired by a GPS device (e.g., a user sensor 220, a hand-held TruPin GPS device offered by E-Z-GO® used by a groundskeeper of the golf course 500 or the golf course 600, a vehicle GPS of the vehicle 10, etc.) from the GNSS satellite 410. The acquired pin GPS positions of the pins and the tee GPS positioned of the tees may, however, only be accurate within a few yards an actual location of the pins and the tees. To correct (e.g., adjust for, account for, etc.) inaccurate or inconsistent acquired positions of the pins and the tees as a result of the GPS drift, the system 400 is configured to determine a corrective position of the pins and the tees based on the GPS data and the corrective position data (e.g., associated with the true positions of the pins and the tees). By doing so, highly accurate positions of the pins, the tees, and the vehicles 10 can all be gathered, and such information provided to golfers and/or operators of the golf course (e.g., via the user portal 230). By way of example, the exact or substantially exact tee to pin distance for a hole can be determined and provided to a golfer and/or operator of the golf course (e.g., via the operator interface 48, a user device of the golfer, the user portal 230, etc.). By way of another example, the exact or substantially exact distance from a ball of the golfer to the pin can be determined and provided to the golfer and/or the user portal 230 (e.g., on a second, third, etc. shot of a hole; via the operator interface 48; based on the corrected position of the vehicle 10, based on the corrected position of the golfer carrying a user sensor 220, etc.).

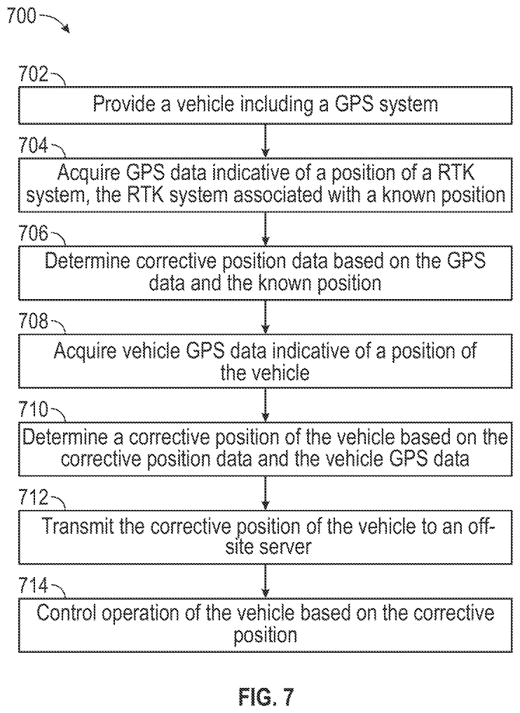

As shown in FIG. 7, a method 700 for operating a vehicle includes steps 702-714. Method 700 may be performed by the system 400 (e.g., the vehicles 10, the off-site server 240, the on-site system 260, the GNSS satellite 410, etc.). At step 702, a vehicle (e.g., vehicle 10) including a GPS system (e.g., GPS sensors, the sensors 90, the user sensors 220, etc.) is provided. At step 704, GPS data or signals (hub GPS data or signals) indicative of a position (hub GPS position) of a RTK system (e.g., a RTK base station or hub, the on-site system 260, etc.) are acquired. The RTK system is associated with a known position such as a fixed, precise, and stationary reference location (e.g., in a clubhouse of a golf course, on the golf course, etc.). The GPS data indicative of the position of the RTK system may be determined based on communication between the RTK system and one or more GNSS satellites (e.g., GNSS satellite 410). At step 706, corrective position data is determined based on the GPS data acquired at step 704 and the known position of the RTK system. The corrective position data may be indicative of an error or difference between the position of the RTK system indicated by the GPS data and the known position of the RTK system caused by GPS drift. At step 708, vehicle GPS data or signals (vehicle GPS data or signals) indicative of a position (vehicle GPS position) of the vehicle is acquired. The vehicle GPS data may be acquired from a first sensor of the vehicle and/or operator (e.g., a GPS sensor, a position sensor, the sensors 90, the user sensors 220, etc.). At step 710, a corrective position of the vehicle is determined based on the corrective position data and the vehicle GPS data. The corrective position may be indicative of a real-time position of the vehicle. In some embodiments, the corrective position is determined by a controller of the vehicle. At step 712, the corrective position is transmitted to an off-site server (e.g., off-site server 250). In embodiments where the corrective position is determined by a controller of the vehicle, the vehicle transmits the corrective position to the off-site server. In some embodiments, the corrective position is determined by the off-site server. In such embodiments, the GPS data and the corrective position data may be transmitted to the off-site server by the vehicle such that step 712 is omitted and step 710 is performed by the off-site server. At step 714, the operation of the vehicle is controlled based on corrective position. In this manner, controlling operation of the vehicle based on the corrective position ensures that a difference between the true position of the vehicle and the GPS position of the vehicle caused by GPS drift does not adversely affect operation of the vehicle.

As utilized herein with respect to numerical ranges, the terms “approximately,” “about,” “substantially,” and similar terms generally mean+/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and descriptions may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the sensors 90, the vehicle controller 100, etc.) and the site monitoring and control system 200 (e.g., the remote systems 240, the user portal 230, the user sensors 220, etc.) as shown in the various exemplary embodiments is illustrative only. Additionally, any element disclosed in one embodiment may be incorporated or utilized with any other embodiment disclosed herein.

1. A vehicle system comprising:
a real-time kinematics (RTK) hub configured to be positioned at a known location at a golf course, the RTK hub including a first communications interface configured to facilitate acquiring a hub GPS position of the RTK hub based on a hub GPS signal acquired from a global navigation satellite system (GNSS) satellite;
a vehicle including:
a chassis;
a plurality of tractive assemblies coupled to the chassis, the plurality of tractive assemblies configured to engage a ground surface to support the vehicle;
a prime mover configured to drive one or more of the plurality of tractive assemblies;
a sensor configured to facilitate acquiring a vehicle GPS position of the vehicle based on a vehicle GPS signal acquired from the GNSS satellite; and
a second communications interface configured to facilitate communications between the vehicle and the RTK hub; and
one or more processing circuits configured to:
determine corrective position data based on the hub GPS position and the known location;
determine a corrective position of the vehicle based on the vehicle GPS position and the corrective position data; and
control an operation of the vehicle based on the corrective position of the vehicle.

2. The vehicle system of claim 1, wherein the one or more processing circuits are configured to permit unrestricted operation of the vehicle when the vehicle GPS position indicates that the vehicle is located in a restricted operation area, but the corrective position indicates that the vehicle is not in the restricted operation area.

3. The vehicle system of claim 2, wherein the one or more processing circuits are configured to limit operation of the vehicle when the vehicle GPS position indicates that the vehicle is not located in the restricted operation area, but the corrective position indicates that the vehicle is in the restricted operation area.

4. The vehicle system of claim 3, wherein the one or more processing circuits are configured to limit operation of the vehicle when the vehicle GPS position indicates that the vehicle is located in the restricted operation area and the corrective position indicates that the vehicle is in the restricted operation area.

5. The vehicle system of claim 4, wherein the one or more processing circuits are configured to permit operation of the vehicle when the vehicle GPS position indicates that the vehicle is not located in the restricted operation area and the corrective position indicates that the vehicle is not in the restricted operation area.

6. The vehicle system of claim 2, wherein the restricted operation area is defined by a predetermined geofence.

7. The vehicle system of claim 1, wherein the one or more processing circuits are configured to use the corrective position to (a) prevent the vehicle from leaving a cart path of the golf course or (b) alter the operation of the vehicle in response to the vehicle leaving the cart path.

8. The vehicle system of claim 1, wherein the vehicle is a golf cart.

9. The vehicle system of claim 1, wherein the one or more processing circuits include at least one of (a) a first processing circuit located on the vehicle, (b) a second processing circuit located on the RTK hub, or (c) a third processing circuit remote from the vehicle and the RTK hub.

10. The vehicle system of claim 9, wherein:
the second processing circuit is configured to determine the corrective position data based on the hub GPS position and the known location;
the first processing circuit is configured to determine the corrective position of the vehicle based on the vehicle GPS position and the corrective position data; and
the third processing circuit is configured to transmit a control signal to the first processing circuit to control the operation of the vehicle based on the corrective position of the vehicle.

11. The vehicle system of claim 1, wherein the one or more processing circuits are configured to:
acquire a pin GPS position for a pin on the golf course and a tee GPS position for a tee on the golf course; and
determine at least one of:
(a) a first distance between the tee and the pin based on the tee GPS position and the pin GPS position;
(b) a second distance between the vehicle and the pin based on the corrective position of the vehicle and the pin GPS position.

12. The vehicle system of claim 11, wherein the vehicle includes a display, and wherein the one or more processing circuits are configured to:
provide, in response to determining the first distance between the tee and the pin based on the tee GPS position and the pin GPS position, the first distance on the display; and
provide, in response to determining the second distance between the vehicle and the pin based on the corrective position of the vehicle and the pin GPS position, the second distance on the display.

13. The vehicle system of claim 11, wherein determining the first distance between the tee and the pin based on the tee GPS position and the pin GPS position includes:
determining a corrective tee position for the tee based on the tee GPS position and the corrective position data;
determining a corrective pin position for the pin based on the pin GPS position and the corrective position data; and
calculating the first distance based on the corrective tee position and the corrective pin position.

14. The vehicle system of claim 11, wherein determining the second distance between the vehicle and the pin based on the corrective position of the vehicle and the pin GPS position includes:
determining a corrective pin position for the pin based on the pin GPS position and the corrective position data; and
calculating the second distance based on the corrective position of the vehicle and the corrective pin position.

15. A golf cart comprising:
a chassis;
a plurality of tractive assemblies;
a prime mover configured to drive one or more of the plurality of tractive assemblies;
a sensor configured to facilitate acquiring a GPS position of the golf cart based on a GPS signal;
a communications interface configured to facilitate communications with a real-time kinematics (RTK) system configured to be positioned at a known location at a golf course; and
a controller configured to:
determine a corrective position of the golf cart based on (i) corrective position data received from the RTK system and (ii) the GPS position of the golf cart; and
facilitate selectively limiting or permitting operation of the prime mover based on the corrective position of the golf cart.

16. The golf cart of claim 15, wherein the controller is configured to facilitate unrestricted operation of the prime mover in a first mode of operation when the GPS position indicates that the golf cart is located in a restricted operation area, but the corrective position indicates that the golf cart is not in the restricted operation area.

17. The golf cart of claim 15, wherein the controller is configured to limit operation of the prime mover in a second mode of operation when the GPS position indicates that the golf cart is not located in a restricted operation area, but the corrective position indicates that the golf cart is in the restricted operation area.

18. The golf cart of claim 15, wherein the controller, via the communications interface, is configured to transmit a position signal associated with the corrective position of the golf cart to a server remote from the golf cart, wherein the server is configured to transmit a control signal to the communications interface based on the position signal, and wherein the controller is configured to selectively limit or permit operation of the prime mover in accordance with the control signal.

19. A vehicle system comprising:
one or more processing circuits including one or more memory devices storing instructions thereon that, when executed by one or more processors, cause the one or more processors to:
acquire first GPS data indicative of a position of a real-time kinematics (RTK) system, the RTK system associated with a known position;
determine corrective position data based on the first GPS data and the known position;
acquire second GPS data indicative of a GPS location of a vehicle;
determine a corrective position of the vehicle based on the corrective position data and the second GPS data; and
control operation of the vehicle based on the corrective position.

20. The vehicle system of claim 19, wherein the instructions, when executed by the one or more processors, cause the one or more processors to transmit the corrective position to a server remote from the vehicle, the server configured to selectively limit or permit operation of the vehicle based on the corrective position.
